(19) United States
(12) Patent Application Publication
(10) Pub. No.: US 2025/0375770 A1
(43) Pub. Date: Dec. 11, 2025

(54) FINGER-MOUNTED DEVICE FOR HOLDING AND USING MICROCENTRIFUGE TUBES

(71) Applicant: University of Central Oklahoma, Edmond, OK (US)

(72) Inventors: James Creecy, Edmond, OK (US); Cooper Blair, Edmond, OK (US)

(21) Appl. No.: 18/736,825

(22) Filed: Jun. 7, 2024

(51) Int. Cl. B01L 9/06

(52) U.S. Cl. CPC B01L 9/06; B01L 2200/087

(57) ABSTRACT

A finger-mounted device comprising a finger attachment and tube receiver that allows microcentrifuge tubes to be mounted and held in position on either the internal side or the external side of a users hand without grasping either the tubes or the tube holder, wherein device allows a user to hold microcentrifuge tubes of various sizes while using a pipette.

### STATEMENT AS TO RIGHTS TO INVENTIONS MADE UNDER FEDERALLY SPONSORED RESEARCH OR DEVELOPMENT

This invention was made without government support.

### FIELD OF THE INVENTION

The present invention generally relates to the field of molecular biology. More specifically, the invention relates to use of microcentrifuge tubes in many aspects of molecular biology.

All of the references, patents. and patent applications that are referred to herein are incorporated by reference in their entirety as if they had each been set forth herein in full. The term “tubes” and the term “microcentrifuge tubes” may be used interchangeably, and neither term is limiting. The disclosure herein goes beyond that needed to support the claims of the particular invention set forth herein. This is not to be construed that the inventor is thereby releasing the unclaimed disclosure and subject matter into the public domain. Rather, it is intended that patent applications will be filed to cover all of the subject matter disclosed below. Also, please note that the terms frequently used below “the invention” or “this invention” is not meant to be construed that there is only one invention being discussed. Instead, when the terms “the invention” or “this invention” are used, it is referring to the particular invention being discussed in the paragraph where the term is used.

### BACKGROUND OF THE INVENTION

A pipette (sometimes spelled as pipet) is a type of laboratory tool commonly used in chemistry and biology to transport a measured volume of liquid. The first simple pipettes were made in glass. Large pipettes continue to be made in glass; others are made in squeezable plastic for situations where an exact volume is not required. The first micropipette was patented in 1957 by Dr. Heinrich Schnitger in Marburg, Germany. The founder of the Eppendorf company, Dr. Heinrich Netheler, inherited the rights and started the commercial production of micropipette tubes in 1961. The company Netheler & Hinz GmbH (now Eppendorf AG) launched the microliter pipette system in 1961. This microliter pipette system allowed precise measurement of liquids and was used with the first microcentrifuge and microcentrifuge tubes which were introduced in 1962. Eppendorf microcentrifuge tubes are used in academic and industrial research laboratories, e.g. in companies in the pharmaceutical, biotech, chemical and food industries. They are also used in laboratories that perform clinical or environmental analysis, in forensic laboratories, and in industrial laboratories where industrial process analysis, production and quality assurance are performed. In life science and biological labs, a microcentrifuge tube may be used multiple applications ranging from sample storage to running reactions and spinning down or separating samples. Eppendorf tubes and similar microcentrifuge tubes are used for preparing, mixing, centrifuging, transporting and storing solid and liquid samples and reagents.

Use of microcentrifuge tubes often requires holding a tube in one hand while extracting a liquid with a pipette held in the other hand. If different liquids held in a plurality of tubes are required in a process, the user must alternate the various tubes held or attempt to hold more than one tube while extracting fluid with a micropipette. Alternating and setting aside each tube in a multi-tube process is confronted with efficiency challenges because the user must typically set aside the micropipette. This alternating back and forth of tube and pipette is particularly problematic when larger scale analytical processes are performed, such as with a 96-well plate.

Attempts have been made to address the aforementioned problem. In Japanese Patent Application JP200529195A, Niimura discloses a disposable reagent pack and an analyzer using the reagent pack. The disposable reagent pack comprises containers housing disposable chips of the required quantity of liquid, at least one waste fluid container part, and at least one solution storing part filled with solutions of a required type. The containers housing the disposable chips, the waste fluid container part, and the reagent container are integrally formed. In European Patent EP3624945B1, Von Belchmann et al. disclose a pipetting assistance system for assisting manual pipetting or dispensing of a plurality of samples in an operating position of a sample receiving assembly by a user-guided pipetting or dispensing device. In U.S. Patent U.S. Pat. No. 6,517,783B2, Horner et al. disclose a reaction receptacle apparatus that includes one or more individual receptacles for containing chemical or biological substances. The one or more receptacles are arranged to be engaged by tubular elements of a substance transfer device for transferring substances into or out of the individual receptacles. Multiple receptacles are coupled to one another by a connecting rib structure that defines straight shoulders along opposite sides of the reaction receptacle apparatus, and the shoulders support the apparatus within reaction receptacle apparatus carrying structures. A contact-limiting element holding structure for holding contact-limiting elements, such as protective tips for tubular elements, is associated with each individual receptacle and holds a contact-limiting element in an operative orientation so as to be operatively engageable by the tubular element of the substance transfer device. A receptacle apparatus manipulating structure permits the reaction receptacle apparatus to be moved from one location to another by a robotic manipulating device, and an information panel presents a surface on which human and/or machine-readable information may be placed. MedicusHealth (https://www.medicus-health.com/wristband-tube-jockey.html) markets a Wristband Tube Jockey that allows a clinician to hold multiple sample tubes holding blood drawn from a patient while continuing to draw blood into additional sample tubes. None of these related disclosures provide the same functionality of the present invention in the same way.

The finger-mounted device of the present invention for holding microcentrifuge tubes is a unique product that has never been seen in the laboratory research space. Currently, it is industry standard that the user picks up the microcentrifuge tube each time a transfer is required and puts it down so they can hold the next tube. This process of picking up and putting down adds time and error to the system.

Recent advances in laboratory techniques have driven up the cost of cutting-edge research. It is not uncommon that a single experiment could cost as much as $10,000. If a sample is contaminated or an error occurs, that experiment is no longer viable and substantial costs may be incurred. There is a clear need for a device would remove the necessity for the user to pick up and put down their microcentrifuge tubes while setting up their experiment and while using a micropipette.

### SUMMARY OF THE INVENTION

In one aspect, the present invention provides a readily accessible finger-mounted device for holding microcentrifuge tubes of various sizes while using a pipette.

In another aspect, the present invention provides a finger attachment and tube receiver that allows microcentrifuge tubes to be mounted and held in position on either the internal side or the external side of a users hand without grasping either the tubes or the tube holder.

In yet another aspect, the internal and external mounting positions and less frequent picking-up and putting-down actions reduces the frequency of alternating motions and risk of sample contamination.

In one aspect, the present invention provides a finger mountable device having a finger attachment assembly preferably configured as a ring-like segmented circle, so it is expandable and can be worn on human fingers of various diameters.

In another aspect, attached on the outside of the ring like assembly are one or a plurality of adjacent circular attachments for holding microcentrifuge tubes.

In another aspect, preferably at least two adjacent circular attachments are configured to hold 0.5 uL tubes and/or 1.5 uL and 2.0 uL tubes.

In another aspect, the device of the present invention may be configured with adjacent circular attachments that allow holding multiple tubes of various sizes, where 0.5 uL and 1.5-2.0 uL tube-sizes are the most common, but larger or smaller tubes may be accommodated.

In another aspect, the material used to fabricate the device of the present invention may comprise a polymer or a metal, and preferably a simi-rigid material.

In another aspect, the device of the present invention may be formed by injection molding a polymer or 3D printed from a hard or semi-rigid polymer, and preferably the entire device is made of the same material although combinations of materials are anticipated.

In one aspect, the device of the present invention is intended to be worn on a single finger of the human hand, although multiple finger attachment assemblies are also anticipated.

In another aspect the finger attachment of the present invention is preferably worn on a middle finger but can be moved based on the user's preference, with the adjacent circular attachments positioned to hold tubes on the inside or backside of the hand on which the device is worn, although the backside position on the hand allows greater freedom of hand use.

In another aspect, the present invention includes a method of use wherein the user would mount a microcentrifuge tube into smaller or larger of the adjacent circular attachments intended for holding microcentrifuge tubes based on the size of the tube.

In another aspect, the user may open a mounted microcentrifuge tube and begin to pipette the contents of the microcentrifuge tube while the tube remains mounted in one of the circular attachments.

In another aspect, when initiating a pipette action from a microcentrifuge tube positioned on the backside of the hand, the user will preferably curl their fingers inward to improve access and visibility of a mounted microcentrifuge tube.

In another aspect, when initiating an action to dispense the contents in the pipette tip into another tube, the user would preferably uncurl their fingers, and the microcentrifuge tube would be positioned out of the way of pipetting.

### BRIEF DESCRIPTION OF THE DRAWINGS

FIG. 1 is a diagram schematically illustrating a first side view of the device of the present invention where the finger attachment of the device is the “ring” section and is preferably intended for mounting on either of the user's middle fingers.

FIG. 2 is a diagram schematically illustrating a second side view of the device of the present invention showing two adjacent circular attachments of the device positioned to hold microcentrifuge tubes of differing sizes in a substantially orthogonal position relative the finger on which the device of the present invention is mounted.

FIG. 3 is a diagram schematically illustrating a second side view of the device of the present invention showing three adjacent circular attachments of the device positioned to hold microcentrifuge tubes of equal or differing sizes in a substantially orthogonal position relative the finger on which the device of the present invention is mounted.

FIG. 4 is a diagram schematically illustrating the device of the present invention positioned toward the inside of the wearer's hand and mounted on a lower middle finger.

FIG. 5 is a diagram schematically illustrating the device of the present invention positioned toward the outside of the wearer's hand and mounted on an upper middle finger.

### DETAILED DESCRIPTION OF PREFERRED EMBODIMENTS OF THE INVENTION

In brief:

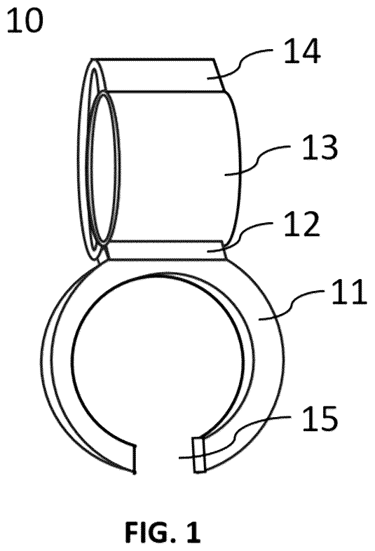

FIG. 1 is a diagram schematically illustrating the finger mounting “ring” portion of the device. The ring is open-ended so that it can expand to fit onto the finger as needed. The ring portion can be made in different sizes to accommodate the finger size of the user. Tubes placed in the adjacent circular attachments are held in a substantially orthogonal position relative the finger on which the device of the present invention is mounted.

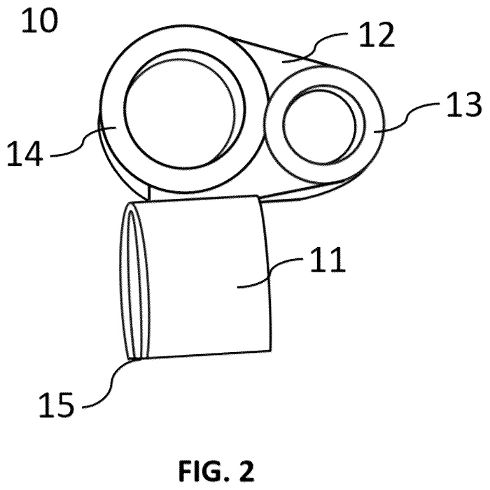

FIG. 2 is a diagram schematically illustrating the microcentrifuge tube holding portion of the device. The microcentrifuge tube holding portion as shown fits two sizes of tubes, but can be constructed to hold more tubes of various sizes. Tubes placed in the adjacent circular attachments are held in a substantially orthogonal position relative the finger on which the device of the present invention is mounted.

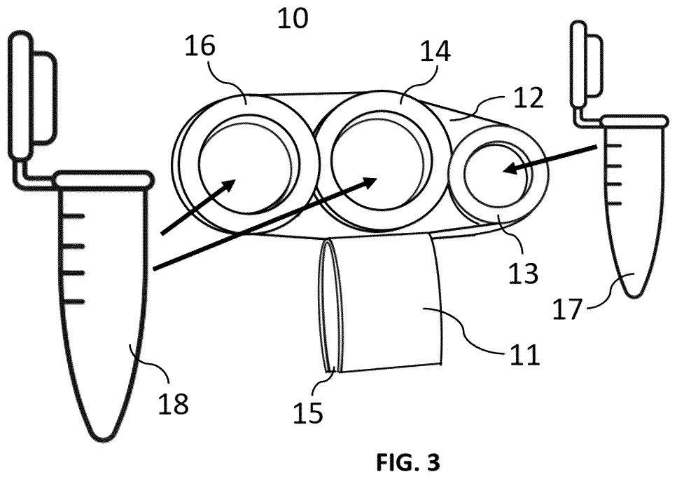

FIG. 3 is a diagram schematically illustrating the microcentrifuge tube holding portion of the device expanded to hold an additional tube. The microcentrifuge tube holding portion as shown fits three tubes, where two are the same size and on is smaller. The tube holding portion can be constructed to hold more tubes of the same or differing sizes, including 0.5 uL tubes and/or 1.5 uL and 2.0 uL tubes. Tubes placed in the adjacent circular attachments are held in a substantially orthogonal position relative the finger on which the device of the present invention is mounted.

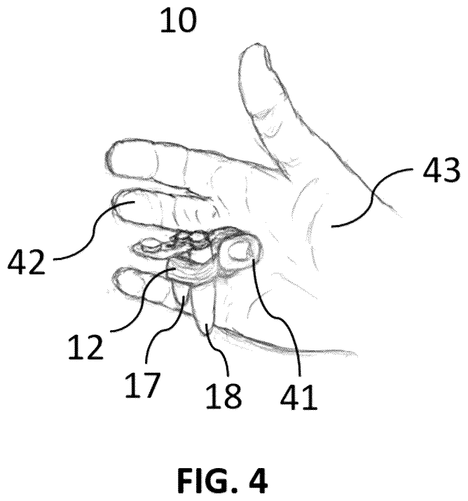

FIG. 4 is a diagram schematically illustrating the device of the present invention positioned toward the inside of the wearer's hand and mounted on a lower middle finger. Preferably, the device of the present invention may be positioned toward the outside of the wearer's hand and mounted on an upper middle finger.

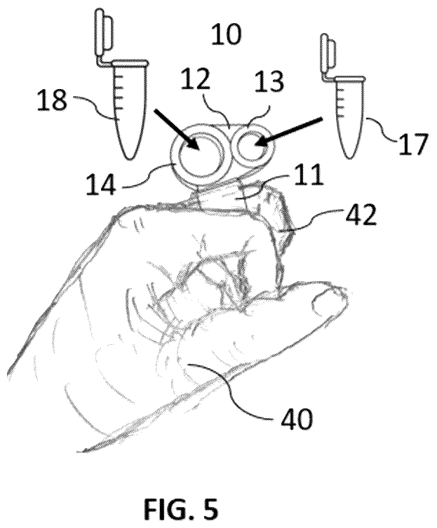

FIG. 5 is a diagram schematically illustrating the device of the present invention positioned toward the outside of the wearer's hand and mounted on an upper middle finger. Preferably, the device of the present invention may be positioned toward the outside of the wearer's hand and mounted on an upper middle finger.

The finger-mounted device of the present invention allows a user to hold onto and control orientation multiple microcentrifuge tubes while using a micropipette. Users of the present invention will understand and appreciate that pipetting to process samples will be accomplished more rapidly than existing methods and with a higher degree of ease and confidence. The present invention allows the microcentrifuge tubes to be mounted on the inside or the outside of the hand and not gripped with the fingers. These internal or external mounting positions and less frequent picking-up and putting-down actions of the tubes and micropipette will reduce the frequency of sample contamination, while increasing process efficiency.

In detail:

Referring now to FIG. 1, a non-limiting diagram shows the finger mounting “ring” portion 11 of the device 10 of the present invention. The ring portion 11 is open-ended 15 so that it can expand to fit onto the finger as needed. The ring portion 11 can be made in different sizes to accommodate the finger size of the user. Tubes placed in the adjacent circular attachments 13 and 14 connected by a tube holding portion 12 to the “ring” portion 11 are held in a substantially orthogonal position relative the finger on which the device 10 of the present invention is mounted.

Referring now to FIG. 2, a non-limiting diagram shows the microcentrifuge tube holding portion 12 of the device 10 of the present invention. The adjacent circular attachments 13 and 14 are configured to hold microcentrifuge tubes of specific sizes, including at least any of 0.5 uL tubes and/or 1.5 uL and 2.0 uL tubes. As shown, two different sizes of tubes can be inserted through the openings of the adjacent circular attachments 13 and 14. The tube holding portion 12 of the device 10 can be constructed to hold more than two tubes of various sizes. Tubes placed in the adjacent circular attachments 13 and 14 connected by the tube holding portion 12 to the “ring” portion 11 are held in a substantially orthogonal position relative the finger on which the device 10 of the present invention is mounted. The ring portion 11 is open-ended 15 so that it can expand to fit onto the finger as needed. The ring portion 11 can be made in different sizes to accommodate the finger size of the user.

Referring now to FIG. 3, a non-limiting diagram shows the microcentrifuge tube holding portion 12 of the device 10 of the present invention expanded to hold an additional tube in an added circular attachment 16. The microcentrifuge tube holding portion 12 as shown fits three tubes, where two are the same size (14, 16) and one is smaller (14). The tube holding portion 12 can be constructed to hold more tubes of the same or differing sizes, including at least 0.5 uL tubes and/or 1.5 uL and 2.0 uL tubes. Tubes 17 and 18 placed in the adjacent circular attachments 13, 14 and 16 connected by a tube holding portion 12 to the “ring” portion 11 are held in a substantially orthogonal position relative the finger on which the device 10 of the present invention is mounted. The ring portion 11 is open-ended 15 so that it can expand to fit onto the finger as needed. The ring portion 11 can be made in different sizes to accommodate the finger size of the user.

Referring now to FIG. 4, a non-limiting diagram shows the device 10 of the present invention positioned toward the inside of the wearer's hand 40 and mounted on a lower middle finger 41. Preferably, the device 10 of the present invention may be positioned toward the outside of the wearer's hand 40 and mounted on an upper middle finger 42. Tubes 17 and 18 placed in the adjacent circular attachments 13 and 14 connected by a tube holding portion 12 to the “ring” portion 11 are held in a substantially orthogonal position relative the finger on which the device 10 of the present invention is mounted. Internal or external mounting positions and less frequent picking-up and putting-down actions of the tubes 17 and 18 and any micropipette in use will reduce the frequency of sample contamination, while increasing process efficiency.

Referring now to FIG. 5, a non-limiting diagram shows the device of the present invention positioned toward the outside of the wearer's hand 40 and mounted on an upper middle finger 42. Preferably, the device 10 of the present invention may be positioned toward the outside of the wearer's hand 40 and mounted on an upper middle finger 42. Tubes 17 and 18 placed in the adjacent circular attachments 13 and 14 connected by a tube holding portion 12 to the “ring” portion 11 are held in a substantially orthogonal position relative the finger on which the device 10 of the present invention is mounted. Internal or external mounting positions and less frequent picking-up and putting-down actions of the any tubes and micropipette in use will reduce the frequency of sample contamination, while increasing process efficiency.

The present invention provides a readily accessible finger-mounted device 10 for holding microcentrifuge tubes of various sizes while using a pipette. The present invention provides a finger attachment “ring” 11 and tube receiver 12 that allows microcentrifuge tubes 17 and 18 to be mounted and held in position on either the internal side or the external side of a users hand 40 without grasping either the tubes 17 and 18 or the tube holder 12.

The internal and external mounting positions and less frequent picking-up and putting-down actions reduces the frequency of alternating motions and risk of sample contamination. The present invention provides a finger mountable device having a finger attachment assembly preferably configured as a ring-like segmented circle, so it is expandable and can be worn on human fingers of various diameters. Attached on the outside of the finger attachment “ring” 11 are one or a plurality of adjacent circular attachments for holding microcentrifuge tubes.

Preferably at least two adjacent circular attachments are configured to hold 0.5 uL tubes and/or 1.5 uL and 2.0 uL tubes. Alternate configurations of the device of the present invention may be configured with adjacent circular attachments that allow holding multiple tubes of various sizes, where 0.5 uL and 1.5-2.0 uL tube-sizes are the most common, but larger or smaller tubes may be accommodated.

The material used to fabricate the device 10 of the present invention may comprise a polymer or a metal, and preferably a simi-rigid material. The device 10 of the present invention may be formed by injection molding a polymer or 3D printed from a hard or semi-rigid polymer, and preferably the entire device 10 is made of the same material although combinations of materials are anticipated.

The device of the present invention is intended to be worn on a single finger of the human hand 40, although multiple finger attachment assemblies are also anticipated. The finger attachment ring 11 of the present invention is preferably worn on a middle finger but can be moved based on the user's preference, with the adjacent circular attachments positioned to hold tubes on the inside or backside of the hand on which the device is worn, although the backside position on the hand 40 allows greater freedom of hand use.

In another aspect, the present invention includes a method of use wherein the user would mount a microcentrifuge tube into smaller or larger of the adjacent circular attachments 13 and 14 intended for holding microcentrifuge tubes 17 and 18 based on the size of each tube. The user may open a mounted microcentrifuge tube 17 and/or 18 and begin to pipette the contents of the opened microcentrifuge tube(s) while the tube remains mounted in one of the circular attachments 13 and 14. When initiating a pipette action from a microcentrifuge tube positioned on the backside of the hand 40, the user will preferably curl their fingers inward to improve access and visibility of a mounted microcentrifuge tube. When initiating an action to dispense the contents in a pipette tip into another tube, the user would preferably uncurl their fingers, and the microcentrifuge tube would be positioned out of the way of pipetting.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A finger-mounted device comprising:
a finger attachment and tube receiver that allows microcentrifuge tubes to be mounted and held in position on either the inside or the backside of a users hand without grasping either the tubes or the tube holder,
wherein said device said holds microcentrifuge tubes of various sizes when using a pipette.

2. The device of claim 1, wherein said finger attachment assembly is preferably configured as a ring-like segmented circle, expandable to be worn on human fingers of various diameters.

3. The device of claim 1, wherein one or a plurality of adjacent circular attachments for holding microcentrifuge tubes are attached on the outside of said ring-like segmented circle.

4. The device of claim 3, wherein preferably at least two adjacent circular attachments are configured to hold 0.5 uL tubes and/or 1.5 uL and 2.0 uL tubes.

5. The device of claim 1, wherein said device is configured with adjacent circular attachments that allow holding multiple tubes of various sizes, including at least tubes in the range of 0.5 uL-2.0 uL tube-sizes.

6. The device of claim 1, wherein said device comprises a polymer or a metal, and preferably a simi-rigid material.

7. The device of claim 1, wherein said device formed by injection molding a polymer or 3D printed from a hard or semi-rigid polymer.

8. The device of claim 7, wherein said device is made of the same material or combinations of materials.

9. A method of using a finger-mounted device that holds microcentrifuge tubes of various sizes while using a pipette, comprising:
mounting said device on a single finger of the human hand and positioned either on the inside or backside of the hand;
mounting at least one microcentrifuge tube into a smaller or larger of one or more adjacent circular attachments connected to said device and intended for holding microcentrifuge tubes;
opening a mounted microcentrifuge tube and extracting the contents of the microcentrifuge tube using said pipette while the tube remains mounted in one of said circular attachments,
wherein, said inside or outside mounting positions of said device and holding said at least one microcentrifuge tube while pipetting lessens the frequency of picking-up and putting-down actions and reduces the frequency of alternating motions and risk of sample contamination.

10. The method of claim 9, wherein the user will preferably curl their fingers inward to improve access and visibility of a mounted microcentrifuge tube when initiating a pipette action from a microcentrifuge tube positioned on the backside of said hand.

11. The method of claim 9, wherein the user will preferably uncurl their fingers, and the microcentrifuge tube would be positioned out of the way of pipetting when initiating an action to dispense the contents in a pipette tip into another tube.
